(19) United States
(12) Patent Application Publication
(10) Pub. No.: US 2016/0368519 A1
(43) Pub. Date: Dec. 22, 2016

(54) DEVICE FOR VENTILATING A STEERING WHEEL SURROUND AND METHOD FOR OPERATING THE DEVICE

(71) Applicant: FORD GLOBAL TECHNOLOGIES, LLC, Deaborn, MI (US)

(72) Inventor: Frederic Stefan, Aachen (DE)

(21) Appl. No.: 15/156,906

(22) Filed: May 17, 2016

(30) Foreign Application Priority Data
Jun. 16, 2015 (DE) 102015211056.7

(51) Int. Cl. B62D 1/06; B60H 1/00; B60H 1/24

(52) U.S. Cl. CPC B62D 1/065; B60H 1/242; B60H 1/0055

(57) ABSTRACT

A device is provided for ventilating a steering wheel surround of a vehicle. The device includes at least one adjustable air vent in the vicinity of the steering wheel, wherein the adjustability of the at least one air vent is configured to reach with an airflow at least one imaginary point on the steering wheel at different rotational angles of the steering wheel. A method for operating the device is also disclosed. In the device the at least one air vent is able to be adjusted synchronously with a rotation of the steering wheel, so that the airflow during and/or after the rotation of the steering wheel approximately follows the movement of the at least one imaginary point on the steering wheel.

### TECHNICAL FIELD

This document relates to a device for ventilating a steering wheel surround of a vehicle. That device comprises at least one adjustable air vent near or in the vicinity of the steering wheel. The adjustability of the air vent is configured to reach with an airflow at least one imaginary point on the steering wheel at different rotational angles of the steering wheel. A method for operating the device is also provided.

### BACKGROUND

Devices for ventilating or heating a steering wheel of a vehicle, in particular a motor vehicle, are known. In particular, the electrical heating of steering wheels is increasingly used in order to counteract a shortfall in waste heat which occurs in particularly efficient motor vehicles. By concentrating heat to points in the vehicle which permit the occupant to feel the heat in a manner which is as direct as possible, the effect which is able to be achieved by a limited amount of heat is maximized. As the steering wheel has direct contact with the hands of the driver on the steering wheel during the journey, a direct influence on the thermal comfort of the driver may be achieved. In this connection it is also particularly significant that the hands, and in particular the fingers, are generally bare and actually have a high degree of sensitivity to heat and cold, which is particularly important for the sensation of thermal comfort.

Electrical steering wheel heating units are quite disadvantageous from the cost perspective, however, and require further measures to be taken in the vehicle, in particular in the electrical system, in order to be able to operate these heating units. Additionally, there is the drawback that in contrast to the heating system, a direct and efficient cooling of the steering wheel by the effects of thermal conductivity would involve a considerably greater degree of complexity and has not been practicable hitherto.

A method and a device for producing an airflow for a motor vehicle are disclosed in DE 10 2008 005 894 A1. In this case, an airflow from one or more opening(s) in a steering wheel is deflected to one or both wrists of a driver. The airflow is, in particular, conducted to two angular regions of the steering wheel which correspond to the so-called “10 to 2” position. “10 to 2” is understood as a steering wheel position in which the left hand of the driver is positioned 60° to the left of the upper center of the steering wheel circumference and the right hand is positioned 60° to the right of the upper center of the steering wheel circumference. The term relates to the similarity of the position of hands on the dial of a traditional analog clock at 10 minutes to 2 o'clock or 1:50.

A drawback with this disclosed method and/or with the device is primarily that conditioned air has to be introduced into the rotatable steering wheel before it is able to escape through openings in the steering wheel at the predetermined points. The construction and implementation of corresponding air guidance elements, in particular ventilation channels, avoiding leakages, noise development, excess pressure loss of the airflow and temperature changes by insufficient thermal insulation, is only able to be implemented with difficulty in the restricted space of the vehicle environment.

### SUMMARY

It is, therefore, an object to provide a device for ventilating a steering wheel surround and a method for operating the device by which the aforementioned drawbacks are avoided.

This object is achieved by a device for ventilating a steering wheel surround as disclosed herein. The device contains at least one adjustable air vent near the steering wheel, wherein the adjustability of the at least one air vent is configured to reach with an airflow at least one imaginary point on the steering wheel at different rotational angles of the steering wheel. In the device, the at least one air vent is able to be adjusted synchronously with a rotation of the steering wheel, so that the airflow during and/or after the rotation of the steering wheel approximately follows the movement of the at least one imaginary point on the steering wheel.

### BRIEF DESCRIPTION OF THE DRAWING FIGURES

FIG. 1 is a schematic representation of the device for ventilating a steering wheel surround of a motor vehicle.

FIG. 2 is a view similar to FIG. 1 but depicting a rotation of the steering wheel.

FIG. 3 is a detailed schematic view illustrating the left-hand and right-hand airflow when the steering wheel is in the straight-ahead position.

FIG. 4 is a detailed schematic view illustrating the left-hand and right-hand airflow when the steering wheel is rotated to the right.

FIG. 5 is a simplified block diagram of the method.

Reference will now be made in detail to the present preferred embodiments of the ventilating device, examples of which are illustrated in the accompanying drawing figures.

### DETAILED DESCRIPTION

“Steering wheel” in this case may also be understood within the meaning of this document as other equivalent devices by which a driver is able to steer or control a vehicle, i.e. for example also a steering bar or a steering arm of a single-track or multi-track vehicle, a steering lever or the like.

A steering wheel rotation is a rotational movement of the steering wheel about its central axis and/or about the steering column which is performed for the purpose of changing the direction of the vehicle. After the end of the steering wheel rotation the steering wheel may be in any angular position relative to the initial position before the rotation and/or relative to its zero position in the straight-ahead position. Thus it may also be rotated. A steering wheel rotation is a steering wheel position which deviates from the straight-ahead position.

“Steering wheel surround” is understood as the region around the steering wheel, the hands of the driver generally being located therein during the journey. The region surrounds the outer circumference of the steering wheel rim and/or the hand bearing surfaces of the steering wheel and extends sufficiently far from the steering wheel that hands placed in whatever manner on the steering wheel are always in this region. The region of the steering wheel surround also encompasses switches and other control devices which may be reached by the driver with the hand on the steering wheel during the journey, such as for example—but not exclusively—for operating the direction indicators, the windshield wipers, the horn, the lights, the radio, the onboard computer, the cruise control or even a gear shift paddle or a gear shift of a steering column gearshift. Options for adjusting the steering wheel such as height adjustment, inclination adjustment or longitudinal adjustment, increase the steering wheel surround by the corresponding adjustment range.

Ventilation of the steering wheel surround means producing at least one airflow which introduces air into the steering wheel surround and, as a result, also forces air out of the steering wheel surround, or even produces a recirculating or circulating airflow inside the steering wheel surround. A temperature control of the steering wheel surround may also be associated with the ventilation of the steering wheel surround, by air at a higher or lower temperature being introduced into the steering wheel surround. Thus a heating or cooling of the steering wheel surround may be implemented. Similarly, a conditioning regarding the air humidity may be associated with the ventilation of the steering wheel surround, by air having a lower or higher absolute air humidity being introduced into the steering wheel surround. Thus, for example, the dehumidification of the steering wheel surround may also be implemented.

At least one adjustable air vent is attached near or in the vicinity of the steering wheel. “Vicinity of the steering wheel” in this case is understood as a distance from the steering wheel or from the steering wheel surround which is sufficiently small that an airflow produced by the air vent is able to reach the steering wheel surround in order to achieve the above-described ventilation.

The adjustability of the at least one air vent may be implemented differently. Here it may be a case of an adjustability regarding the direction of the airflow. This may be achieved, for example, by two sets of vanes which are arranged vertically relative to one another on the air vents and which are adjustable in terms of angle, one thereof permitting upward/downward adjustment and the other permitting right/left adjustment. Many other different designs are conceivable and are used in the air vents of air-conditioning systems which are common in motor vehicles and which are typically attached to the instrument panel. Also, an adjustability relative to the fanning-out of the airflow may be provided, i.e. the airflow may emerge from the outlet concentrated into a narrow jet or fanned out broadly. Moreover, such adjustment options are already used in the aforementioned air vents. Finally, an adjustability relative to air quantity and/or air velocity and/or intensity of the emerging airflow may also be implemented. For example, by a variable throttling of the air vent, i.e. by opening or closing, the range and intensity of the airflow may be adjusted. Similarly, the adjustability of the air quantity and/or air velocity and/or intensity of the emerging airflow may be achieved by variable control of a fan which is arranged upstream of the air vent. A combination of the different possibilities for adjustment relative to air direction, fanning-out and intensity is naturally possible.

In any case, the adjustability of the at least one air vent has to be configured to reach with an airflow at least one imaginary point on the steering wheel at different rotational angles of the steering wheel. In this case, points on the steering wheel which are able to be reached should primarily be the points where the hands of the driver are predominantly placed. If the steering wheel is rotated in order to change the direction of the vehicle, these points should also be able to be reached by the airflow. Reaching these points means in this case that at these points an air velocity may be produced which is able to be felt by the driver with a bare hand.

Here there is also the possibility of providing a plurality of air vents so that by the combination thereof an improved coverage of the steering wheel surround may be achieved. For example, a first air vent may cover a first region of the steering wheel surround, a second air vent may cover a second region and so forth. An imaginary point on the steering wheel which leaves the first region when the steering wheel is rotated and enters the second region may initially be reached by the airflow of the first air vent and subsequently by the airflow of the second air vent. Depending on the geometric complexity of the steering wheel, the steering wheel surround and the installation conditions in the vehicle, a greater number of air vents and associated regions of the steering wheel surround may be also provided.

By reaching those points on the steering wheel at which the hands of the driver are predominantly positioned, it is possible to supply conditioned air to the driver's hands and the surroundings thereof directly, and thereby directly influence the sensation of thermal comfort of the driver. As these points on the steering wheel may be reached even when the steering wheel is rotated, it is not only possible to effect a sensation of comfort when the vehicle is traveling straight ahead but also when cornering.

In order to permit a constant ventilation of specific points on the steering wheel which is not interrupted by the rotational movements of the driver on the steering wheel, the device is characterized in that the at least one air vent may be adjusted synchronously with a rotation of the steering wheel, so that the airflow during and/or after the rotation of the steering wheel approximately follows the movement of the at least one imaginary point on the steering wheel. The synchronous adjustment of the at least one air vent may be implemented in this case, for example, by a mechanical connection of the air vent to the steering wheel or parts fastened to the steering wheel, in particular a steering column, which transmits a rotational movement of the steering wheel into a movement of at least of one adjustment device of the air vent. Similarly, it is possible to implement the synchronous adjustment in a mechatronic manner. By means of a sensor unit, the rotational angle of the steering wheel may be detected at the same time and the adjustment of the at least one air vent may be controlled, based on an evaluation of the detected angle in a control unit and the activation of at least one actuator. A corresponding angle sensor on the steering wheel or on the steering column of the vehicle may be considered as a sensor unit, but also for example an evaluation unit which is based on other measurement and operating data from the onboard power supply of the vehicle, such as for example information from wheel sensors or acceleration sensors, determines the rotation of the steering wheel.

It is advantageous if the at least one adjustable air vent is a nozzle, the outflow cross section thereof being located substantially parallel to the steering wheel plane. This means that the outflow direction of the nozzle is substantially parallel to the rotational axis of the steering wheel, wherein the nozzle is expediently arranged spaced apart from the steering wheel in the longitudinal direction of the vehicle, so that by a directional adjustment and/or variable fanning-out of the airflow a region of the steering wheel surround which is as large as possible may be reached. In the usual arrangement in motor vehicles of adjustable air vents of the air-conditioning unit which are attached to the instrument panel in the vicinity of the steering wheel, these air vents may be used as the air vents of the device.

It is particularly advantageous if the device contains means which are configured to adjust the temperature and/or air humidity of the airflow of the at least one air vent. The sensation of comfort of the driver may be particularly easily influenced when the air of the airflow is correspondingly conditioned.

By providing warm air, an effective heating of the driver's hands may be implemented, the energy requirement thereof being relatively low. For example, when warming up the vehicle in cold conditions, by heating the driver's hands by means of the device a rapid heating effect may be achieved, wherein it is possible to avoid the energy-intensive heating of cold components with a high thermal capacity in the vehicle interior or on the steering wheel. Similarly, a further heating effect may also be achieved if the waste heat of the engine and/or the performance of possibly installed (additional) heating devices is not sufficient to bring the entire interior of the vehicle or the vehicle surroundings to a comfortable temperature via a conventional vehicle heating unit. Moreover, it is possible to achieve a perceptible heating effect even when the driver's surroundings are not able to be fully heated because, for example, the vehicle does not have an enclosed interior or the vehicle is a convertible with an open roof.

By providing cool and/or dry air the driver's hands may be effectively cooled. In a similar manner to heating the driver's hands, a cooling effect directly felt by the driver may thus be implemented in a rapid and energy-saving manner. Also, in a hot vehicle interior or in an open vehicle in a hot environment, a subjectively effective cooling action may also be implemented with a low use of cooling power.

It is also advantageous if the device contains measuring means which are configured to detect the position of at least one hand on the steering wheel. As a result, it is possible to orientate the airflow of the at least one air vent directly to the actual position of this hand and/or to the actual positions of the driver's hands. Thus a more powerful ventilation effect may be achieved in comparison with an orientation to an assumed and/or conventional position of the driver's hands, such as for example the so-called “10 to 2” position. The at least one imaginary point which the airflow follows during the rotation of the steering wheel may be determined using information from these measuring means. In this manner, a movement of at least one hand on the steering wheel may also be taken into account. For example, when gripped by the driver, which is required when the steering wheel is rotated sufficiently far that it is not able to be rotated any further, without positioning the hands elsewhere on the steering wheel, the imaginary point on the steering wheel, which the airflow follows, may be displaced from the old hand position to the new hand position Similarly, it is possible to detect an alteration to the positioning of the hands when traveling straight ahead and accordingly to change the ventilation of the steering wheel surround.

In preferred embodiments of the device these measuring means contain at least one capacitive sensor, a pressure sensor or a camera.

Advantageously, the device contains further measuring means which are configured to detect moisture on at least one hand and/or the steering wheel surface. Using information about moisture on the surface of the skin of a hand, by considering the evaporation cooling associated therewith, the subjectively felt effect of an airflow on the thermal comfort may be more accurately estimated. Thus the desired effect on the sensation of comfort of the driver may be implemented more sensitively and/or more efficiently.

It is also preferred if the device contains at least one switch by which it may be activated and/or deactivated. If the device is combined with other devices in the vehicle, in particular the air conditioning unit, by means of the switch the additional advantage is also achieved that the at least one air vent of the device is used for different functions, wherein the ventilation of the steering wheel surround is one of these functions. The switch may also be linked to other functions of the vehicle, for example opening and/or closing the cover or the roof in a convertible or any other open or partially open vehicle.

It is also advantageous if the device contains a steering wheel, the surface thereof having a low heat penetration coefficient. By means of the heat penetration coefficient, which may be calculated from the thermal conductivity, the density and the thermal capacity of a body, it is possible to describe the temperature sensation upon contact with this body. As heat is either removed from or supplied to the hand by thermal conduction, due to the contact of one hand with a steering wheel—depending on the temperature of the steering wheel—an effect produced by the airflow using the device and/or an intended effect on the sensation of thermal comfort of the driver may be influenced and/or reduced thereby. A cold steering wheel feels colder, the higher the heat penetration coefficient on its surface. Similarly, a warm or hot steering wheel feels hotter, the higher the heat penetration coefficient on its surface. Thus it is expedient if the steering wheel surface has a low heat penetration coefficient. In this case, a value which is less than 1 W_{S}^{0.5}m⁻²K⁻¹ is understood as low. In particular, the regions of the steering wheel surface which are generally in direct contact with the hands of the driver, such as for example the outer steering wheel circumference and/or steering wheel rim or hand bearing surfaces of the steering wheel, have to be considered.

In the method for operating the device, the at least one adjustable air vent in the vicinity of the steering wheel is adjusted such that the airflow during and/or after the rotation of the steering wheel approximately follows the movement of at least one imaginary point on the steering wheel. Following an imaginary point on the steering wheel with the airflow means in this case that the air velocity produced by the airflow in the region of this point on the steering wheel is able to be felt by a bare hand located there and continues to be felt when the steering wheel is rotated with the bare hand still located there. If, however, the driver moves away from this imaginary point, in an imaginary coordinate system fixed to the steering wheel, the air velocity may be reduced. An object here is to concentrate the airflow at this point in order to minimize the energy requirement for producing and optionally conditioning the airflow. Thus it is expedient to orientate the airflow such that a local maximum air velocity is present at the imaginary point. The adjustment of the at least one air vent in order to follow the at least one imaginary point when rotating the steering wheel may be carried out continuously or in stages.

In one advantageous embodiment of the method, the at least one adjustable air vent in the vicinity of the steering wheel is adjusted such that during and/or after the rotation of the steering wheel the direction of the airflow is adjusted. This means that the airflow with regard to its orientation follows the rotation of the steering wheel.

In a further advantageous embodiment of the method, the at least one adjustable air vent in the vicinity of the steering wheel is adjusted such that during and/or after the rotation of the steering wheel the fanning-out of the airflow is adjusted. As a result, for example, if by rotating the steering wheel a driver's hand is moved away from the air vent approximately perpendicular to the outflow direction and at the same time the airflow is simultaneously fanned out, the hand may also be reached.

In a further advantageous embodiment of the method, the at least one adjustable air vent in the vicinity of the steering wheel is adjusted such that during and/or after the rotation of the steering wheel the intensity of the airflow is adjusted. This may be achieved, for example—but not exclusively—by a variable throttling of the air vent, i.e. by opening or closing or by variable control of a fan which is arranged upstream of the air vent. This type of adjustment permits an alteration of the air velocity on the driver's hand to be minimized, namely when a driver's hand is moved away from the air vent approximately parallel to the outflow direction by the rotation of the steering wheel, by increasing the intensity of the airflow.

It is advantageous during and/or after the rotation of the steering wheel that the temperature of the airflow from the at least one adjustable air vent in the vicinity of the steering wheel be altered. In this manner, it is possible to compensate for a temperature difference of the air on a driver's hand, which results from the hand being moved away from the air vents in a variable manner.

In a preferred embodiment of the method, the method is activated or deactivated by operating a switch assigned to the device. The driver may thus consciously switch on or switch off the function.

Finally, it is particularly advantageous if the method is activated when a cover or roof and/or at least one window of the vehicle is opened. The limitation of the air-conditioning of the vehicle interior may thus be at least partially compensated by the method.

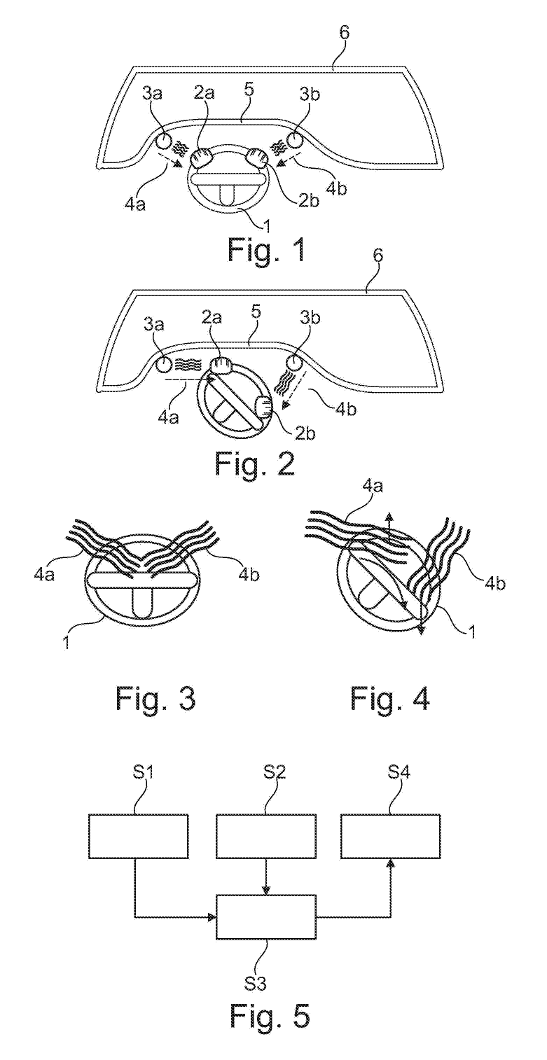

An exemplary embodiment is shown in FIG. 1 to FIG. 5.

FIG. 1 shows the arrangement of the device in the vehicle in the straight-ahead position of the steering wheel. The driver's hands 2a, 2b are located in the “10 to 2” position on the steering wheel 1. The left hand 2a is located on the left-hand side of the steering wheel 1 and the right hand 2b on the right-hand side of the steering wheel 1 in the direction of travel. The air vents 3a, 3b are nozzles, the outflow cross sections thereof being located substantially parallel to the steering wheel plane. The air vents 3a, 3b produce an airflow 4a, 4b which is oriented toward the driver's hands 2a, 2b. The left-hand air vent 3a is offset to the left of the steering wheel 1 in the vicinity of the steering wheel and ventilates the left-hand part of the steering wheel surround, in particular the driver's left hand 2a with an airflow 4a. The right-hand air vent 3b is arranged offset to the right of the steering wheel 1 in the vicinity of the steering wheel and ventilates the right-hand part of the steering wheel surround, in particular the driver's right hand 2b with an airflow 4b. The air vents 3a, 3b are attached to the instrument panel 5 which is located below the windshield 6.

In FIG. 2 the arrangement of the device is shown during a rotation of the steering wheel. The steering wheel 1 is rotated to the right by approximately 45°, whereby the positioning of the driver's hands 2a, 2b is altered. The driver's left hand 2a is displaced slightly upward and to the right, whilst the driver's right hand 2b is displaced downward and slightly to the right. In the embodiment of the method, the air vents 3a, 3b are adjusted so that the airflow 4a, 4b is altered. The left-hand air vent 3a is adjusted such that the left-hand airflow 4a follows the driver's left hand 2a. To this end, the left-hand airflow 4a is oriented further upward. The right-hand air vent 3b is adjusted such that the right-hand airflow 4b follows the driver's right hand 2b. To this end, the right-hand airflow 4b is oriented further downward.

FIG. 3 shows the left-hand airflow 4a and the right-hand airflow 4b with reference to the steering wheel 1 in the straight-ahead position of the steering wheel.

The orientation of the left-hand air flow 4a and the right-hand airflow 4b, when the steering wheel 1 is rotated to the right and the “10 to 2” position of the driver's hands 2 is adopted, is visible in FIG. 4.

In FIG. 5 a simplified sequence of an embodiment of the method is shown. In step S1 the positions of the driver's hands 2a, 2b are detected. This may be carried out by means of a sensor unit, or even as an estimate based on empirical data and/or driving information. The conditioning of the air for ventilating the steering wheel surround by the air-conditioning unit of the vehicle takes place in step S2. At the same time, the air temperature and air humidity is set. In step S3 the requirements for the steering wheel ventilation are processed, wherein by considering the positioning of the driver's hands 2a, 2b and the boundary conditions predetermined by the air-conditioning unit of the vehicle regarding air-conditioning, the presettings for ventilation of the steering wheel surround and, in particular, the driver's hands 2a, 2b may be set. Finally, in step S4 the direction, fanning-out and intensity of the airflow 4a, 4b on the at least one air vent 3a, 3b are set.

1. A device for ventilating a steering wheel surround of a vehicle, comprising at least one adjustable air vent in a vicinity of a steering wheel, wherein the adjustability of the at least one adjustable air vent is configured to reach with an airflow at least one imaginary point on the steering wheel at different rotational angles of the steering wheel, wherein
the at least one adjustable air vent is able to be adjusted synchronously with a rotation of the steering wheel, so that the airflow during and/or after the rotation of the steering wheel approximately follows a movement of the at least one imaginary point on the steering wheel.

2. The device as claimed in claim 1, wherein the at least one adjustable air vent is a nozzle, having an outflow cross section located substantially parallel to a steering wheel plane.

3. The device as claimed in claim 2, wherein the device contains means which are configured to adjust temperature and/or air humidity of the airflow from the at least one adjustable air vent.

4. The device as claimed in claim 2, wherein the device contains measuring means which are configured to detect a position of at least one hand on the steering wheel.

5. The device as claimed in claim 4, wherein the measuring means contain at least one capacitive sensor.

6. The device as claimed in claim 4, wherein the measuring means contain at least one pressure sensor.

7. The device as claimed in claim 4, wherein the measuring means contain at least one camera.

8. The device as claimed in claim 4, wherein the device contains further measuring means which are configured to detect moisture on at least one hand and/or a surface of the steering wheel.

9. The device as claimed in claim 8, wherein the device contains at least one switch by which it may be activated and/or deactivated.

10. The device as claimed in claim 1, wherein the device contains the steering wheel with a surface thereof having a lower heat penetration coefficient.

11. A method for operating a device as claimed in claim 1, wherein the at least one adjustable air vent in the vicinity of the steering wheel is adjusted such that the airflow during and/or after the rotation of the steering wheel approximately follows movement of at least one imaginary point on the steering wheel.

12. The method as claimed in claim 11, wherein the at least one adjustable air vent is adjusted such that during and/or after the rotation of the steering wheel a direction of the airflow is adjusted.

13. The method as claimed in claim 11, wherein the at least one adjustable air vent is adjusted such that during and/or after the rotation of the steering wheel a fanning-out of the airflow is adjusted.

14. The method as claimed in claim 11, wherein the at least one adjustable air vent is adjusted such that during and/or after the rotation of the steering wheel an intensity of the airflow is adjusted.

15. The method as claimed in claim 11, wherein during and/or after the rotation of the steering wheel a temperature of the airflow from the at least one adjustable air vent is altered.

16. The method as claimed in claim 11, wherein the method is activated or deactivated by operation of a switch assigned to the device.

17. The method as claimed in claim 16, wherein the method is activated when a cover or roof and/or at least one window of the vehicle is opened.
